(19) United States
(12) Patent Application Publication
(10) Pub. No.: US 2015/0190789 A1
(43) Pub. Date: Jul. 9, 2015

(54) PREPARATION AND APPLICATION OF ULTRA-DEEP HYDRODESULFURIZATION MULTI-METAL BULK CATALYST OF LAYERED STRUCTURE

(71) Applicant: DALIAN INSTITUTE OF CHEMICAL PHYSICS, CHINESE ACADEMY OF SCIENCES, Dalian, Liaoning (CN)

(72) Inventors: Can Li, Dalian (CN); Zongxuan Jiang, Dalian (CN); Yandie Chen, Dalian (CN); Tiefeng Liu, Dalian (CN)

(73) Assignee: DALIAN INSTITUTE OF CHEMICAL PHYSICS, CHINESE ACADEMY OF SCIENCES, Dalian, Liaoning (CN)

(21) Appl. No.: 14/420,167

(22) PCT Filed: Nov. 23, 2012
(86) PCT No.: PCT/CN2012/085119

§ 371 Date: Feb. 6, 2015

(30) Foreign Application Priority Data
Sep. 18, 2012 (CN) 201210347747.5

(51) Int. Cl. B01J 23/889; B01J 37/03; C10L 1/08; B01J 37/30; B01J 35/10; C10G 45/08; B01J 23/888; B01J 37/08

(52) U.S. Cl. CPC B01J 23/8898; B01J 23/8885; B01J 37/038; B01J 37/08; B01J 37/30; B01J 35/1019; B01J 35/1038; B01J 35/1042; C10G 45/08; C10L 1/08; C10L 2200/0446; C10L 2270/026

(57) ABSTRACT

An unsupported multi-metallic layered catalyst which comprises two or more Group VIB metals, one Group VIII metals, and one divalent metal, is used in ultra-deep hydrodesulfurization of diesel. And on oxide basis, it comprises 1-50 wt % Group VIII metals, 1-50 wt % divalent metals, and 5-60 wt % two Group VIB metals. Under hydrodesulfurization conditions, it can reduce sulfur content (in the form of 4, 6-DMDBT) of diesel from 500 wppm to less than 10 wppm. Besides, it also lowers the cost of catalysts.

### FIELD OF THE INVENTION

The present invention relates to a multi-metallic layered bulk catalyst of ultra-deep hydrodesulfurization, the preparation of said catalyst, and the use of said catalyst in ultra-deep hydrodesulfurization (HDS).

### BACKGROUND OF THE INVENTION

Due to dwindling oil reserves, issues of heavy crude oil and poor crude oil becoming serious, the product of high-sulfur crude oil increasing worldwide yearly, and in each country more stringent environmental legislations limiting sulfur contents in fuels, developing hydrogenation catalysts with super high activity not only has received increasing attention in refining industry, but also become a key part in hydrotreating field. The sulfur compounds in oil are the main source of air pollution. The organic sulfur compounds can poison the three-way catalysts irreversibly in the tail gas cleanup system of engines, and produce SOₓ by combusting which not only results in acid rain and particulate matter, but also leads to increasing foggy days. Because SOₓ causes serious harm to environment and health, it has attracted wide attention. Therefore, many countries have enacted strict regulations to limit sulfur contents in fuels. Europe had legislated a sulfur level in diesel less than 10 wppm in 2005. China has firstly performed a Jing V clean diesel index of a sulfur content less than 10 ppmw at Jun. 1, 2012 in Beijing, and will implement a sulfur diesel emission standard index equivalent to Euro IV (<50 ppmw) across the country at Jan. 1, 2014. It is expected to promote the sulfur diesel emission standard index equivalent to Euro V (<10 ppmw) in whole country in 2016.

So far, common hydrodesulfurization catalysts such as Co—Mo/Al₂O₃, Ni—Mo—P/Al₂O₃, Ni—W—B/Al₂O₃, Ni—Co—Mo/Al₂O₃ and Co—W/Al₂O₃ are widely used in industry. However, more stringent environmental legislations limit catalysts with low activity that cannot satisfy the demand of ultra-deep hydrodesulfurization, and improve an urgent need to develop new catalysts with super high HDS activity. Changing operating conditions and using new reactor need huge investment. And by contrast, in current production apparatus under the current operating condition, improving catalytic activity by developing a new catalyst is a more economical, more feasible method for HDS.

The main sulfur containing compounds present in diesel are thiols, sulfides, thiophene and its derivatives, benzothiophene (BT) and its derivatives, and dibenzothiophene (DBT) and its derivatives, in which 4,6-DMDBT is the most difficult to be removed in HDS process. The reason is that over conventional catalysts, the limited catalytic effect of supports just promotes activity via large contact area between reactants and supports or synergy between active ingredients and supports. So it is difficult to make substantial improvement of HDS activity of the common supported catalysts. However, multi-metallic bulk catalyst, i.e. multi-metallic unsupported catalyst is a high activity catalyst, due to various active ingredients, and more active sites than supported catalysts. Among them, a multi-metallic bulk catalyst consisted of NiMoW showed high hydrodesulfurization activity in recent references and patents, and aroused extensive attention.

U.S. Pat. Nos. 6,299,760, 6,156,695, 6,783,663, 6,712,955 and 6758963 reported preparation and application of a new type NiMoW bulk catalyst, and its hydrodesulfurization activity is three fold activity of other commercial catalysts. During the synthesis, ammonia water was used as chelating agent to react with Ni²⁺, the nickel ammonia complex will decompose Ni²⁺ gradually which reacts Mo species and W species in solution to form NiMoW precursor, and finally via calcination and sulfuration the NiMoWS was synthesized. However, the drawbacks of methods are that using ammonia water will cause environmental pollution. Apart from that, complex of Ni²⁺ and ammonia is so stable that it is difficult to release Ni²⁺, and therefore there is still partial complex of Ni²⁺ in solution resulting in large quantities of waste water. Besides, the prepared catalysts in these patents possess low surface area (<110 m²/g) and volume (<0.2 ml/g), while in HDS reaction of diesel these catalysts shown high HDS activity only under conditions of high pressure (>6 MPa).

G. Alonso-Nunez et al. in their work (Applied Catalysis A: General 304 (2006)124-130); Applied Catalysis A: General 302 (2006)177-184) and Catalysis Letters 99(2005)65-71)) reported several preparation methods of NiMoW bulk catalysts using different materials and several sulfidation agents. The catalysts they prepared had special flaked shape and feasible high surface area, but the synthesis method was so complex that the steps were also complex and the raw materials were expensive, leading to high costs of catalysts and difficulty to achieve industrialization.

Chinese Patent No. CN1339985A also developed a route to synthesize NiMoW catalyst, in which via reaction of Mo, W salts and basic nickel carbonate in water, the solid precursor was obtained, and then sulfided the solid precursor. During the reaction, at least part of the metal component is required in solid form.

Due to using insoluble basic nickel carbonate source and that the nature of the synthesis reaction is a ion-exchanged reaction between ions and solids, it's not easy to prepare catalyst with small size. Chinese Patent nos. CN101544904, CN101153228A and CN101733120A also reported preparation and application of a triple NiMoW bulk catalyst in HDS of diesel. Though the catalyst exhibits higher activity, it still has low surface area and pore volume.

Based on present literature reports, there still exist several shortages about synthesis methods: a) materials used are not so green to environment; b) the cost of catalyst is high; c) surface area and pore volume of catalyst need further increasing.

Therefore, it is necessary to develop HDS catalysts with high activity under relatively low temperature, while still possess high surface area, optimum porosity, sufficient pore volume and readily available raw materials, friendly to environment, lower price. There is also a need for bulk multi-metallic catalysts to have low cost for industrialization.

### SUMMARY OF THE INVENTION

The present invention provides an unsupported multi-metallic layered catalyst with super high HDS activity.

The invention also provides a process for preparation of the catalyst.

The invention provides a layer-structured multi-metallic bulk catalyst of ultra-deep hydrodesulfurization containing two or more Group VIB metals, one Group VIII metals, and at least one divalent metal. And on oxide basis, it comprises 1-50 wt % Group VIII metals, 1-50 wt % divalent metals, and 5-60 wt % two Group VIB metals.

In one preferable embodiment, the divalent metal suitably is selected from zinc, magnesium, copper, iron or manganese, Group VIII metals are selected from nickel or cobalt, and two Group VIB metals are selected from molybdenum and tungsten.

In yet another preferable embodiment, the molar ratio of Group VIII metals to divalent metals is in the range of from 20:1 to 1:20, the molar ratio of two Group VIB metals is in the range of from 5:1 to 1:5.

In yet another embodiment, a process to prepare the aforementioned catalyst is provided. The process comprises:

a) dissolving Group VIII metal precursor and one divalent metal precursor in water, adding aqueous solution of basic precipitant to said solution to form a catalyst precipitate, then obtaining a layer-structured catalyst precursor.

b) combining the slurry of mentioned catalyst precursor and polar solvent containing at least two Group VIB metals together for ion-exchanged reaction, filtering the catalyst precursor, washing, drying and calcining catalyst precursor at 400-500° C. for 2-10 h, to form a layer-structured bulk multi-metallic catalyst containing two Group VIB metals, one Group VIII metals, and one divalent metal.

In said preparation, the concentration of solution of Group VIII metal soluble salts lies in the range of from 0.01 to 0.3 M, the concentration of solution of divalent metal soluble salts lies in the range of from 0.01 to 0.3 M, and the concentration of layer-structured catalyst precursor is in the range of from 0.01 to 0.9 M, and the concentration of at least two Group VIB metal soluble salts solving in polar solvent is in the range of from 0.01 to 0.2 M.

The concentration of the aqueous solution of basic precipitant lies in the range of from 0.01 to 0.6 M, the amount of said aqueous solution of basic precipitant is to enable the pH of the solution between 6.0˜9.0, after the coprecipitation reaction in step a).

In said preparation, the basic precipitant mentioned in step a) is selected from sodium hydroxide, potassium hydroxide, sodium carbonate, potassium carbonate, sodium bicarbonate, potassium bicarbonate, ammonia, urea, ammonium bicarbonate, ammonium carbonate or mixtures of any two or more thereof.

The precipitation reaction temperature mentioned in step a) is in the range of from 50 to 150° C. for 10 to 25 h.

The ion-exchanged reaction temperature mentioned in step b) is in the range of from 50 to 150° C. for 4 to 10 h.

The pH of ion-exchanged reaction system mentioned in step b) is in the range of from 1 to 11, via using an acid (e.g. nitric acid) or base (e.g., aqueous ammonia) to adjust.

In a preferable embodiment, the Group VIII metal soluble salt is selected from nickel nitrate, nickel acetate, nickel sulfate, nickel chloride or cobalt nitrate, cobalt acetate, cobalt sulfate, or cobalt chloride.

In yet another embodiment, the divalent metal soluble salt is selected from zinc nitrate, zinc acetate, zinc sulfate, zinc chloride or magnesium nitrate, magnesium acetate, magnesium sulfate, magnesium chloride or copper nitrate, copper acetate, copper sulfate, copper chloride or ferrous nitrate, ferrous acetate, ferrous sulfate, ferrous chloride, manganese nitrate, manganese acetate, manganese sulfate, or manganese chloride.

In yet another preferably embodiment, at least two Group VIII metal soluble salts are one selected from ammonium molybdate or sodium molybdate and the other selected from ammonium tungstate, ammonium meta-tungstate, or sodium tungstate.

In yet another preferably embodiment, the invention provides a use of aforementioned catalyst in the HDS reaction of fuels in the presence of organic sulfur compounds.

In yet another preferable embodiment, the reaction conditions of said HDS reaction are: temperatures in the range of from 280 to 400° C., hydrogen partial pressures in the range of from 1 to 20 MPa, H₂/oil ratio in the range of from 50 to 1000 Nm³/m³, and typical liquid hourly space velocity in the range of from 0.1 to 10 h⁻¹.

In yet another preferable embodiment, the process of pretreating the catalysts before carrying out HDS reaction includes: a) grinding, kneading, and extrusion molding; b) in a fixed-bed reactor, carrying out sulfidation in-situ in mixture of 1-15% sulfur compound and hydrogen at in the range of from 300 to 450° C. for 2-10 h.

In yet another preferable embodiment, sulfur compound is selected from hydrogen sulfide, carbon disulfide or dimethyl disulfide.

Thus compared to the prior art, this invention has several advantages as follows:

1) This invention uses layer-structured compounds as catalyst precursor and based on that, further synthesizes multi-metallic bulk catalyst with layered structure. Besides, the synthesis process is simple and green to environment, and catalysts can be produced in industry.

2) The synthesized catalysts possess special layered structure and high active metal dispersion, leading to more active sites and more contact between reactants and metal atoms.

3) Adding cheep divalent metals (e.g. zinc, magnesium, copper, iron et. al) to catalysts lowers the cost.

4) The catalyst of the present invention is used in ultra deep hydrodesulfurization of sulfur compounds and shows high HDS activity. Under mild hydrodesulfurization conditions, the catalysts can reduce sulfur content (in the form of 4,6-DMDBT) of diesel from 500 ppm to less than 10 ppm, exhibiting super high HDS activity.

5) From XRD pattern, it can be found that the prepared catalysts possess layered structure. Via ion-exchanged reaction, active metals were introduced into the layers of the catalysts successfully, resulting in better metal dispersion and more active sites, and leading to high HDS activity.

### BRIEF DESCRIPTION OF THE DRAWINGS

FIG. 1 shows the X-ray diffraction patterns of NiZn-LHS precursor and Cat-A catalyst prepared in Example 1. From XRD analysis, it is revealed that the diffraction peak of NiZn-LHS at 2θ=12.4° (ascribed to (003) facet) corresponds to interlayer spacing d, and via ion-exchanged reaction the corresponding diffraction peak of Cat-A shifts to 2θ=10.4°. By calculating, the interlayer spacing d value increases from 7.1 Å to 12.4 Å, indicating that the interlayer spacing is swelled by anions of Mo and W. Based on XRD analysis, it is illustrated that the catalyst precursor NiZn-LHS with layered structure was synthesized successfully. By ion-exchanged reaction, active metals Mo and W were introduced into catalysts successfully, resulting in better metal dispersion and more active sites. Besides, addition of cheep divalent metals also lower the catalyst cost.

### DETAILED DESCRIPTION OF THE INVENTION

This invention provides a multi-metallic bulk catalyst of layered structure, which comprises two or more Group VIB metals, one Group VIII metals, and one divalent metal. And on oxide basis, it comprises 1-50 wt % Group VIII metals, 1-50 wt % divalent metals, and 5-60 wt % two Group VIB metals.

In this invention, the divalent metal preferably is selected from zinc, magnesium, copper, iron and manganese, Group VIII metals are selected from nickel or cobalt, and two Group VIB metals are selected from molybdenum and tungsten.

In this invention, the molar ratio of Group VIII metals to divalent metals is in the range of from 20:1 to 1:20, the molar ratio of two Group VIB metals is in the range of from 5:1 to 1:5.

In this invention, the bulk multi-metallic catalyst was synthesized based on layered structure via ion-exchanged reaction, such as Ni (or Co)ZnMoW, Ni (or Co)MnMoW, Ni (or Co)CuMoW, Ni (or Co)FeMoW, Ni (or Co)MgMoW and so on. By ion-exchanged reaction, active anionic groups of two Group VIB metals were introduced into the layers of the catalysts successfully, resulting in better metal dispersion and more active sites.

The preparation of the catalyst in this invention is stated as follow:

a) dissolving Group VIII metal soluble salt and one divalent metal soluble salt in water for coprecipitation, then obtaining a layer-structured catalyst precursor;

b) combining the slurry of said catalyst precursor and solution containing at least two Group VIB metals together for ion-exchanged reaction in the presence of surfactant agent, water, and organic agent.

The preparation of the catalyst in this invention is stated in detail as follows:

a) dissolving Group VIII metal precursor and one divalent metal precursor in water, adding aqueous solution of basic precipitant to said solution for coprecipitation and then obtaining layered catalyst precursor;

b) combining the slurry of mentioned catalyst precursor and polar solution containing at least two Group VIB metals together for ion-exchanged reaction, filtering the catalyst precursor; washing, drying and calcining the catalyst precursor at 400-500° C. for 2-10 h, then obtaining a layer-structured multi-metallic bulk catalyst containing two Group VIB metals, one Group VIII metals, and one divalent metal.

In said preparation, the concentration of solution of Group VIII metal soluble salt lies in the range of from 0.01 to 0.3 M, the concentration of solution of divalent metal soluble salt lies in the range of from 0.01 to 0.3 M, of which the concentration of layered catalyst precursor is in the range of from 0.01 to 0.9 M, and the concentration of at least two Group VIB metal soluble salts solving in polar solvent is in the range of from 0.01 to 0.2 M.

The concentration of the aqueous solution of basic precipitant lies in the range of from 0.01 to 0.6 M, the amount of said aqueous solution of basic precipitant is to enable the pH of the solution between 6.0˜9.0, after the coprecipitation reaction in step a).

In said preparation, the basic precipitant mentioned in step a) is selected from sodium hydroxide, potassium hydroxide, sodium carbonate, potassium carbonate, sodium bicarbonate, potassium bicarbonate, ammonia, urea, ammonium bicarbonate, ammonium carbonate or mixtures of any two or more thereof.

The precipitation reaction temperature mentioned in step a) is in the range of from 50 to 150° C. for 10 to 25 h.

The ion-exchanged reaction temperature mentioned in step b) is in the range of from 50 to 150° C. for 4 to 10 h.

The pH of ion-exchanged reaction system mentioned in step b) is in the range of from 1 to 11, via using an acid (e.g. nitric acid) or base (e.g., aqueous ammonia) to adjust.

In yet another preferable embodiment, the Group VIII metal soluble salt is selected from nickel nitrate, nickel acetate, nickel sulfate, nickel chloride or cobalt nitrate, cobalt acetate, cobalt sulfate, or cobalt chloride.

In yet another embodiment, the divalent metal soluble salt is selected from zinc nitrate, zinc acetate, zinc sulfate, zinc chloride or magnesium nitrate, magnesium acetate, magnesium sulfate, magnesium chloride or copper nitrate, copper acetate, copper sulfate, copper chloride or ferrous nitrate, ferrous acetate, ferrous sulfate, ferrous chloride, manganese nitrate, manganese acetate, manganese sulfate, or manganese chloride.

In yet another preferable embodiment, a mixture of at least two Group VIII metal soluble salts are one selected from ammonium molybdate or sodium molybdate and the other selected from ammonium tungstate, ammonium meta-tungstate, or sodium tungstate.

In yet another preferable embodiment, the invention provides a use of aforementioned catalyst in the HDS reaction of fuels in the presence of organic sulfur compounds.

In yet another preferable embodiment, the reaction conditions of said HDS reaction are: temperatures in the range of from 280 to 400° C., hydrogen partial pressures in the range of from 1 to 20 MPa, H₂/oil ratio in the range of from 50 to 1000 Nm³/m³, and typical liquid hourly space velocity in the range of from 0.1 to 10 h⁻¹.

In yet another preferable embodiment, the process of pretreating the catalyst before carrying out HDS reaction includes: a) grinding, kneading, and extrusion molding; b) in a fixed-bed reactor, carrying out sulfidation in-situ in mixture of sulfur compound and hydrogen atmosphere at in the range of from 300 to 450° C. for 2-10 h.

In yet another preferable embodiment, sulfur compound is selected from hydrogen sulfide, carbon disulfide or dimethyl disulfide.

From XRD analysis of catalyst, it can be concluded that the NiZnMoW catalyst possess layered structure. By ion-exchanged reaction, the interlayer spacing increases, indicating active metals Mo and W were introduced into catalysts successfully, resulting in better metal dispersion and more active sites.

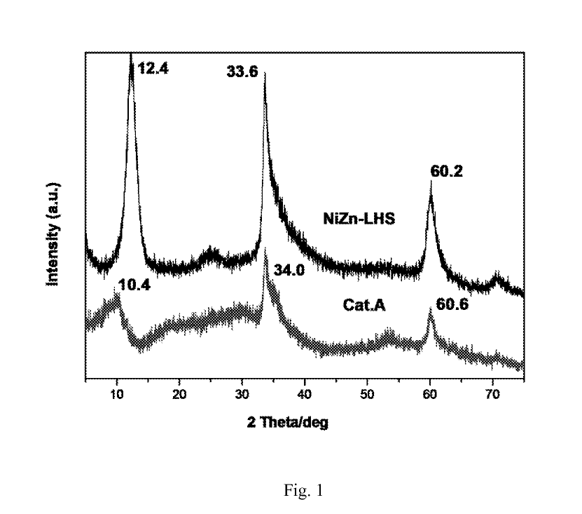

FIG. 1 shows the X-ray diffraction patterns of NiZn-LHS precursor and Cat-A catalyst prepared in Example 1. From XRD analysis, it is revealed that the diffraction peak of NiZn-LHS at 2θ=12.4° (ascribed to (003) facet) corresponds to interlayer spacing d, and via ion-exchanged reaction the corresponding diffraction peak of Cat-A shifts to 2θ=10.4°. By calculating, the interlayer spacing d value increases from 7.1 Å to 12.4 Å, indicating that the interlayer spacing is swelled by anions of Mo and W. Based on XRD analysis, it is illustrated that the catalyst precursor NiZn-LHS with layered structure was synthesized successfully. By ion-exchanged reaction, active metals Mo and W were introduced into catalysts successfully, resulting in better metal dispersion and more active sites. Besides, addition of cheep divalent metals also lower the catalyst cost.

### EXAMPLES

The following examples illustrate this invention, but they don't limit the invention scope of claims. For example, according to experiment results we can prepare a multi-metallic unsupported catalyst composed of two or more Group VIB metals, one Group VIII metals, and one divalent metal, of which the divalent metal is selected from zinc, magnesium, copper, iron and manganese, Group VIII metals are selected from nickel or cobalt and two Group VIB metals are selected from molybdenum and tungsten. Here this invention illustrates examples of NiZnMoW, NiMnMoW, NiCuMoW, NiFeMoW and NiMgMoW, but that doesn't mean other metals cannot be used.

### Example 1

### Preparation of NiZnMoW Bulk Catalyst

a) 29.08 g of nickel nitrate (0.1 mol Ni²⁺) and 1.49 g of zinc nitrate (0.005 mol Zn²⁺) were dissolved in 0.2 L of deionized water, aqueous solution of NaOH (0.2 M) was added to the above solution with constant stirring to maintain the pH=12, and then the solution was heated to reaction temperature to form a aqua solution. Keeping the reflux reaction at 80° C. for 25 h to obtain aqua precipitate, filtering the precipitate and washing, then the catalyst precursor with layered structure (NiZn-LHS) was obtained. The aqua catalyst precursor was dispersed into 0.2 L of deionized water to form slurry (a);

b) 5.4 g of ammonium molybdate (0.03 mol Mo⁶⁺) and 7.2 g of ammonium meta-tungstate (0.03 mol W⁶⁺) were dissolved in 0.03 L of deionized water, and the resulting molybdate/tungstate solution was heated to reaction temperature with continuing stirring to form a colorless solution (b). The above slurry (a) was heated to reaction temperature and was added to the colorless solution (b) to form an aqua solution. The aqua solution was kept refluxing at 80° C. for 5 h to get aqua precipitate. The NiZnMoW catalyst (16.0 g) was prepared by filtering, washing and drying aqua precipitate at 120° C. Via BET measurement using nitrogen, the surface area and pore volume are 140 m²/g and 0.40 ml/g, respectively.

c) the catalyst was aqua powder, and via element analysis (XRF) its general formula is ZnO.4NiO.MoO₃.WO₃. The catalyst in this example is marked Cat-A, the XRD pattern of precursor and calcined sample of Cat-A was listed in FIG. 1. Before HDS reaction, the catalyst was pre-sulfided in 10% H₂S/H₂ atmosphere at 400° C. for 2 h, and the flow rate of 10% H₂S/H₂ gas was 60 mL/min.

### Example 2

### Preparation of NiZnMoW Bulk Catalyst

29.08 g of nickel nitrate (0.1 mol Ni²⁺) and 2.91 g of zinc nitrate (0.01 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (16.4 g) of this example is marked Cat-B whose morphology is similar to Cat-A. Via BET measurement using nitrogen, the surface area and pore volume are 142 m²/g and 0.42 ml/g, respectively.

### Example 3

### Preparation of NiZnMoW Bulk Catalyst

29.08 g of nickel nitrate (0.1 mol Ni²⁺) and 4.36 g of zinc nitrate (0.015 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (16.8 g) of this example is marked Cat-C which is aqua powder. Via BET measurement using nitrogen, the surface area and pore volume are 145 m²/g and 0.45 ml/g, respectively.

### Example 4

### Preparation of NiZnMoW Bulk Catalyst

29.08 g of nickel nitrate (0.1 mol Ni²⁺) and 5.81 g of zinc nitrate (0.02 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (17.5 g) of this example is marked Cat-D which is aqua powder. Via BET measurement using nitrogen, the surface area and pore volume are 148 m²/g and 0.46 ml/g, respectively.

### Example 5

### Preparation of NiZnMoW Bulk Catalyst

29.08 g of nickel nitrate (0.1 mol Ni²⁺) and 7.27 g of zinc nitrate (0.025 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (18.7 g) of this example is marked Cat-E which is aqua powder. Via BET measurement using nitrogen, the surface area and pore volume are 149 m²/g and 0.47 ml/g, respectively.

### Example 6

### Preparation of NiZnMoW Bulk Catalyst

29.08 g of nickel nitrate (0.1 mol Ni²⁺) and 14.9 g of zinc nitrate (0.05 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (19.0 g) of this example is marked Cat-F which is aqua powder. Via BET measurement using nitrogen, the surface area and pore volume are 146 m²/g and 0.44 ml/g, respectively.

### Example 7

### Preparation of NiZnMoW Bulk Catalyst

29.08 g of nickel nitrate (0.1 mol Ni²⁺) and 20.4 g of zinc nitrate (0.07 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (20.3 g) of this example is marked Cat-G which is aqua powder. Via BET measurement using nitrogen, the surface area and pore volume are 144 m²/g and 0.42 ml/g, respectively.

### Example 8

### Preparation of NiZnMoW Bulk Catalyst

29.08 g of nickel nitrate (0.1 mol Ni²⁺) and 23.3 g of zinc nitrate (0.08 mol Zn²⁺) were used instead of 29.08 g of nickel nitrate (0.1 mol Ni²⁺) and 1.49 g of zinc nitrate (0.005 mol Zn²⁺) of Example 1, then the catalyst was prepared following the precipitation route described in Example 1. The multi-metallic bulk catalyst (21.4 g) of this example is marked Cat-H which is aqua powder. Via BET measurement using nitrogen, the surface area and pore volume are 142 m²/g and 0.41 ml/g, respectively.

### Example 9

### Preparation of NiZnMoW Bulk Catalyst

29.08 g of nickel nitrate (0.1 mol Ni²⁺) and 29.1 g of zinc nitrate (0.1 mol Zn²) were used instead of 29.08 g of nickel nitrate (0.1 mol Ni²⁺) and 1.49 g of zinc nitrate (0.005 mol Zn²) of Example 1, then the catalyst was prepared following the precipitation route described in Example 1. The multi-metallic bulk catalyst (22.3 g) of this example is marked Cat-I which is aqua powder. Via BET measurement using nitrogen, the surface area and pore volume are 142 m²/g and 0.42 ml/g, respectively.

### Example 10

Except using 5.4 g of ammonium molybdate (0.03 mol Mo⁶⁺) and 14.4 g of ammonium meta-tungstate (0.06 mol W⁶⁺) instead of 5.4 g of ammonium molybdate (0.03 mol Mo⁶⁺) and 7.2 g of ammonium meta-tungstate (0.03 mol W⁶⁺) of Example 1, then the catalyst was prepared following the precipitation route described in Example 1. The multi-metallic bulk catalyst (16.7 g) of this example is marked Cat-J which is aqua powder. Via BET measurement using nitrogen, the surface area and pore volume are 143 m²/g and 0.44 ml/g, respectively.

### Example 11

Except using 10.8 g of ammonium molybdate (0.06 mol Mo⁶⁺) and 5.4 g of ammonium meta-tungstate (0.03 mol W⁶⁺) instead of 5.4 g of ammonium molybdate (0.03 mol Mo⁶⁺) and 7.2 g of ammonium meta-tungstate (0.03 mol W⁶⁺) of Example 1, then the catalyst was prepared following the precipitation route described in Example 1. The multi-metallic bulk catalyst (17.2 g) of this example is marked Cat-K which is aqua powder. Via BET measurement using nitrogen, the surface area and pore volume are 145 m²/g and 0.42 ml/g, respectively.

### Example 12

Except performing reaction at 50° C. for 10 h instead of at 80° C. for 25 h at step a), then the catalyst was prepared following the precipitation route described in Example 1. The multi-metallic bulk catalyst (16.1 g) of this example is marked Cat-L which is aqua powder. Via BET measurement using nitrogen, the surface area and pore volume are 142 m²/g and 0.42 ml/g, respectively.

### Example 13

Except performing reaction at 50° C. for 25 h instead of at 80° C. for 25 h at step a), then the catalyst was prepared following the precipitation route described in Example 1. The multi-metallic bulk catalyst (16.1 g) of this example is marked Cat-M which is aqua powder. Via BET measurement using nitrogen, the surface area and pore volume are 143 m²/g and 0.43 ml/g, respectively.

### Example 14

Except performing reaction at 150° C. for 10 h instead of at 80° C. for 25 h at step a), then the catalyst was prepared following the precipitation route described in Example 1. The multi-metallic bulk catalyst (16.2 g) of this example is marked Cat-N which is aqua powder. Via BET measurement using nitrogen, the surface area and pore volume are 144 m²/g and 0.43 ml/g, respectively.

### Example 15

Except performing reaction at 150° C. for 25 h instead of at 80° C. for 25 h at step a), then the catalyst was prepared following the precipitation route described in Example 1. The multi-metallic bulk catalyst (16.0 g) of this example is marked Cat-O which is aqua powder. Via BET measurement using nitrogen, the surface area and pore volume are 143 m²/g and 0.43 ml/g, respectively.

### Example 16

Except performing reaction at 50° C. for 4 h instead of at 80° C. for 25 h at step a), then the catalyst was prepared following the precipitation route described in Example 1. The multi-metallic bulk catalyst (16.0 g) of this example is marked Cat-P which is aqua powder. Via BET measurement using nitrogen, the surface area and pore volume are 144 m²/g and 0.44 ml/g, respectively.

### Example 17

Except performing reaction at 50° C. for 10 h instead of at 80° C. for 25 h at step a), then the catalyst was prepared following the precipitation route described in Example 1. The multi-metallic bulk catalyst (16.2 g) of this example is marked Cat-Q which is aqua powder. Via BET measurement using nitrogen, the surface area and pore volume are 145 m²/g and 0.46 ml/g, respectively.

### Example 18

Except performing reaction at 150° C. for 4 h instead of at 80° C. for 25 h at step a), then the catalyst was prepared following the precipitation route described in Example 1. The multi-metallic bulk catalyst (16.3 g) of this example is marked Cat-R which is aqua powder. Via BET measurement using nitrogen, the surface area and pore volume are 149 m²/g and 0.48 ml/g, respectively.

### Example 19

Except performing reaction at 150° C. for 10 h instead of at 80° C. for 25 h at step a), then the catalyst was prepared following the precipitation route described in Example 1. The multi-metallic bulk catalyst (16.2 g) of this example is marked Cat-S which is aqua powder. Via BET measurement using nitrogen, the surface area and pore volume are 142 m²/g and 0.41 ml/g, respectively.

### Example 20

Except calcining the catalyst at 400° C. for 2 h under air atmosphere before performing HDS reaction and the catalyst was pre-sulfided in 10% H₂S/H₂ atmosphere, then the catalyst was prepared following the precipitation route described in Example 1. The multi-metallic bulk catalyst (14.1 g) of this example is marked Cat-T which is brown powder. Via BET measurement using nitrogen, the surface area and pore volume are 145 m²/g and 0.42 ml/g, respectively.

### Example 21

### Preparation of NiMnMoW Bulk Catalyst

a) 29.08 g of nickel nitrate (0.1 mol Ni²⁺) and 7.5 g of manganese nitrate (0.03 mol Mn²⁺) were dissolved in 0.2 L of deionized water, aqueous solution of NaOH (0.2 M) was added to the above solution with constant stirring to maintain the pH=12, and then the solution was heated to reaction temperature to form a grayish-green solution. Keeping the reflux reaction at 80° C. for 25 h to obtain grayish-green precipitate, filtering the precipitate and washing, then the catalyst precursor with layered structure (NiMn-LHS) was obtained. The grayish-green catalyst precursor was dispersed into 0.2 L of deionized water to form slurry (a);

b) 5.4 g of ammonium molybdate (0.03 mol Mo⁶⁺) and 7.2 g of ammonium meta-tungstate (0.03 mol W⁶⁺) were dissolved in 0.03 L of deionized water, and the resulting molybdate/tungstate solution was heated to reaction temperature with continuing stirring to form a colorless solution (b). The above slurry (a) was heated to reaction temperature and was added to the colorless solution (b) to form a grayish-green solution. The grayish-green solution was kept refluxing at 80° C. for 5 h to get grayish-green precipitate. The NiMnMoW catalyst (15.9 g) was prepared by filtering, washing and drying grayish-green precipitate at 120° C. Via BET measurement using nitrogen, the surface area and pore volume are 140 m²/g and 0.48 ml/g, respectively.

c) the catalyst was grayish-green powder, and via XRF its general formula is MnO.4NiO.MoO₃.WO₃. The catalyst of this example is marked Cat-U. Before HDS reaction, the catalyst was pre-sulfided in 10% H₂S/H₂ atmosphere at 400° C. for 2 h, and the flow rate of 10% H₂S/H₂ gas was 60 mL/min.

### Example 22

### Preparation of NiCuMoW Bulk Catalyst

a) 29.08 g of nickel nitrate (0.1 mol Ni²⁺) and 12.0 g of copper nitrate (0.05 mol Cu²⁺) were dissolved in 0.2 L of deionized water, aqueous solution of NaOH (0.2 M) was added to the above solution with constant stirring to maintain the pH=12, and then the solution was heated to reaction temperature to form a blue-green solution. Keeping the reflux reaction at 80° C. for 25 h to obtain blue-green precipitate, filtering the precipitate and washing, then the catalyst precursor with layered structure (NiCu-LHS) was obtained. The blue-green catalyst precursor was dispersed into 0.2 L of deionized water to form slurry (a);

b) 5.4 g of ammonium molybdate (0.03 mol Mo⁶⁺) and 7.2 g of ammonium meta-tungstate (0.03 mol W⁶⁺) were dissolved in 0.03 L of deionized water, and the resulting molybdate/tungstate solution was heated to reaction temperature with continuing stirring to form a colorless solution (b). The above slurry (a) was heated to reaction temperature and was added to the colorless solution (b) to form a blue-green solution. The blue-green solution was kept refluxing at 80° C. for 5 h to get blue-green precipitate. The NiCuMoW catalyst (16.1 g) was prepared by filtering, washing and drying blue-green precipitate at 120° C. Via BET measurement using nitrogen, the surface area and pore volume are 138 m²/g and 0.37 ml/g, respectively.

c) the catalyst was blue-green powder, and via XRF) its general formula is CuO.4NiO.MoO₃.WO₃. The catalyst of the example is marked Cat-V. Before HDS reaction, the catalyst was pre-sulfided in 10% H₂S/H₂ atmosphere at 400° C. for 2 h, and the flow rate of 10% H₂S/H₂ gas was 60 mL/min.

### Example 23

### Preparation of NiFeMoW Bulk Catalyst

a) 29.08 g of nickel nitrate (0.1 mol Ni²⁺) and 14.4 g of ferrous nitrate (0.05 mol Fe²⁺) were dissolved in 0.2 L of deionized water, aqueous solution of NaOH (0.2 M) was added to the above solution with constant stirring to maintain the pH=12, and then the solution was heated to reaction temperature to form an emerald solution. Keeping the reflux reaction at 80° C. for 25 h to obtain emerald precipitate, filtering the precipitate and washing, then the catalyst precursor with layered structure (NiFe-LHS) was obtained. The emerald catalyst precursor was dispersed into 0.2 L of deionized water to form slurry (a);

b) 5.4 g of ammonium molybdate (0.03 mol Mo⁶⁺) and 7.2 g of ammonium meta-tungstate (0.03 mol W⁶⁺) were dissolved in 0.03 L of deionized water, and the resulting molybdate/tungstate solution was heated to reaction temperature with continuing stirring to form a colorless solution (b). The above slurry (a) was heated to reaction temperature and was added to the colorless solution (b) to form an emerald solution. The emerald solution was kept refluxing at 80° C. for 5 h to get emerald precipitate. The NiFeMoW catalyst (16.2 g) was prepared by filtering, washing and drying emerald precipitate at 120° C. Via BET measurement using nitrogen, the surface area and pore volume are 142 m²/g and 0.41 ml/g, respectively.

c) the catalyst was emerald powder, and via XRF its general formula is FeO.4NiO.MoO₃.WO₃. The catalyst of the example is marked Cat-W. Before HDS reaction, the catalyst was pre-sulfided in 10% H₂S/H₂ atmosphere at 400° C. for 2 h, and the flow rate of 10% H₂S/H₂ gas was 60 mL/min.

### Example 24

### Preparation of NiMgMoW Bulk Catalyst

a) 29.08 g of nickel nitrate (0.1 mol Ni²⁺) and 12.8 g of magnesium nitrate (0.05 mol Mg²⁺) were dissolved in 0.2 L of deionized water, aqueous solution of NaOH (0.2 M) was added to the above solution with constant stirring to maintain the pH=12, and then the solution was heated to reaction temperature to form a aqua solution. Keeping the reflux reaction at 80° C. for 25 h to obtain aqua precipitate, filtering the precipitate and washing, then the catalyst precursor with layered structure (NiMg-LHS) was obtained. The aqua catalyst precursor was dispersed into 0.2 L of deionized water to form slurry (a);

b) 5.4 g of ammonium molybdate (0.03 mol Mo⁶⁺) and 7.2 g of ammonium meta-tungstate (0.03 mol W⁶⁺) were dissolved in 0.03 L of deionized water, and the resulting molybdate/tungstate solution was heated to reaction temperature with continuing stirring to form a colorless solution (b). The above slurry (a) was heated to reaction temperature and was added to the colorless solution (b) to form a aqua solution. The aqua solution was kept refluxing at 80° C. for 5 h to get aqua precipitate. The NiMgMoW catalyst (15.7 g) was prepared by filtering, washing and drying aqua precipitate at 120° C. Via BET measurement using nitrogen, the surface area and pore volume are 145 m²/g and 0.45 ml/g, respectively.

c) the catalyst was aqua powder, and via XRF its general formula is MgO.4NiO.MoO₃.WO₃. The catalyst of the example is marked Cat-X. Before HDS reaction, the catalyst was pre-sulfided in 10% H₂S/H₂ atmosphere at 400° C. for 2 h, and the flow rate of 10% H₂S/H₂ gas was 60 mL/min.

### Example 25

### Performance of Catalyst During HDS Reaction

For the catalytic tests, the diesel distillates with a sulfur content of 500 wppm (4, 6-DMDBT was dissolved in declin) was chosen, and the reaction was carried out in a fixed-bed reactor. The reaction conditions include a hydrogen pressure of 3.0 Mpa, catalyst of 0.5 g, reaction temperature of 300° C., LHSV of 9 h⁻¹ and an H₂/oil ratio of 800 Nm³/m³. Besides, the sulfur contents of liquid samples were analyzed by ANTEK sulfur analyzer.

During the HDS reaction of diesel distillates with catalysts prepared in this invention, it can be found that Cat-A, Cat-E, Cat-J, Cat-O, Cat-S and Cat-T show the best activity, in which Cat-A can reduce sulfur content from 500 ppm to 5 ppm, and Cat-I can reduce sulfur content from 500 ppm to 15 ppm. The sulfur contents of diesel distillates over those catalysts after HDS reaction were shown in Table 1.

TABLE 1
The activity of catalysts during HDS reaction

| | Sulfur contents | Specific |
|---|---|---|
| Catalysts | of product (ppm) | activity |
| Cat-A | 5 | 1353 |
| Cat-B | 6 | 1194 |
| Cat-C | 11 | 782 |
| Cat-D | 7 | 1073 |
| Cat-E | 5 | 1353 |
| Cat-F | 8 | 978 |
| Cat-G | 30 | 373 |
| Cat-H | 28 | 393 |
| Cat-I | 15 | 626 |
| Cat-J | 5 | 1353 |
| Cat-K | 6 | 1194 |
| Cat-L | 12 | 735 |
| Cat-M | 11 | 782 |
| Cat-N | 6 | 1194 |
| Cat-O | 5 | 1353 |
| Cat-P | 15 | 626 |
| Cat-Q | 13 | 694 |
| Cat-R | 6 | 1194 |
| Cat-S | 5 | 1353 |
| Cat-T | 5 | 1353 |
| Cat-U | 8 | 978 |
| Cat-V | 20 | 507 |
| Cat-W | 19 | 526 |
| Cat-X | 23 | 429 |
| Commercial | 130 | 100 |
| catalyst | | |

Commercial catalyst was provided by China PetroChemical Corporation, and its composition is Co₃O₄.2.2NiO.5.9MoO₃.2WO₃.

The activity of catalysts in this invention was represented by specific activity. Namely after running 200 h, when the specific activity of reference catalyst is 100, the activity of catalysts in this invention is specific activity. The specific activity is calculated according to the equation 1, where Sf and Sp are the concentrations of sulfur in the feed and product using our catalysts, respectively, while Sfr and Spr are the sulfur contents in the feed and product using the commercial reference catalyst, respectively.

The specific activity=100×[(1/Sp)0.65−(1/Sf)0.65]/[(1/Spr)0.65−(1/Sfr)0.65] (1)

In general, unsupported multi-metallic layered catalysts with high surface area, pore volume in this invention were prepared and exhibited super-high HDS activity. Due to layered structure and ion-exchanged property, active metals Mo and W were introduced into catalysts successfully, resulting in better metal dispersion and more active sites. Under mild HDS reaction conditions, the catalyst can reduce sulfur content (in the form of 4,6-DMDBT) of diesel from 500 ppm to less than 10 ppm, reaching a low sulfur level. Besides, addition of cheep divalent metals also lowers the catalyst cost.

1. A layer-structured multi-metallic bulk catalyst of ultra-deep hydrodesulfurization which is a mixed oxide metal catalyst comprising two or more Group VIB metals, one Group VIII metal, and one divalent metal;
on oxide basis, said catalyst comprises 1-50 wt % Group VIII metal, 1-50 wt % divalent metals, and 5-60 wt % two Group VIB metals;
the molar ratio of Group VIII metals to divalent metals is in the range of from 20:1 to 1:20;
the molar ratio of the two Group VIB metals is in the range of from 5:1 to 1:5; the surface area and pore volume are in the range of from 110-150 m²/g and 0.2-0.5 ml/g, respectively.

2. The catalyst of claim 1, wherein the divalent metal, is selected from zinc, magnesium, copper, iron and manganese, Group VIII metals is selected from nickel or cobalt, and two Group VIB metals are selected from molybdenum and tungsten.

3. A method of preparing the catalyst of claim 1, comprising the following steps:
a) dissolving Group VIII metal precursor and one divalent metal precursor in water, adding aqueous solution of basic precipitant to said solution for coprecipitation, and then obtaining a layer-structured catalyst precursor;
b) combining the slurry of said catalyst precursor and polar solvent containing at least two Group VIB metals together for ion-exchanged reaction, filtering, washing, drying and calcining the catalyst precursor at 400-500° C. for 2-10 h, to form a layer-structured multi-metallic bulk catalyst containing two Group VIB metals, one Group VIII metals, and one divalent metal.

4. The method of claim 3, wherein the concentration of solution of Group VIII metal soluble salt lies in the range of from 0.01 to 0.3 M, the concentration of solution of divalent metal soluble salt lies in the range of from 0.01 to 0.3 M, the concentration of layer-structured catalyst precursor is in the range of from 0.01 to 0.9 M, and the concentration of at least two Group VIB metal soluble salts solving in polar solvent is in the range of from 0.01 to 0.2 M;
the concentration of the aqueous solution of basic precipitant lies in the range of from 0.01 to 0.6 M, the amount of said aqueous solution of basic precipitant is to enable the pH of the solution between 6.0˜9.0, after the coprecipitation reaction in step a).

5. The method of claim 3, wherein the precipitation reaction temperature in step a) is in the range of from 50 to 150° C. for 10 to 25 h;
the ion-exchanged reaction temperature in step b) is in the range of from 50 to 150° C. for 4 to 10 h;
the pH of ion-exchanged reaction system in step b) is in the range of from 1 to 11, via using an acid (e.g. nitric acid) or base (e.g., aqueous ammonia) to adjust.

6. The method of 3, wherein the basic precipitant in step a) is selected from the group consisting of sodium hydroxide, potassium hydroxide, sodium carbonate, potassium carbonate, sodium bicarbonate, potassium bicarbonate, ammonia, urea, ammonium bicarbonate, ammonium carbonate, and mixtures of two or more thereof.

7. The method of claim 3, wherein the Group VIII metal soluble salt is selected from the group consisting of nickel nitrate, nickel acetate, nickel sulfate, nickel chloride or cobalt nitrate, cobalt acetate, cobalt sulfate, cobalt chloride; the divalent metal soluble salt is selected from zinc nitrate, zinc acetate, zinc sulfate, zinc chloride or magnesium nitrate, magnesium acetate, magnesium sulfate, magnesium chloride, copper nitrate, copper acetate, copper sulfate, copper chloride or ferrous nitrate, ferrous acetate, ferrous sulfate, ferrous chloride or manganese nitrate, manganese acetate, manganese sulfate, or manganese chloride; a mixture of at least two Group VIII metal soluble salts are one selected from ammonium molybdate or sodium molybdate and the other selected from ammonium tungstate, ammonium meta-tungstate, or sodium tungstate.

8. A method removing an organic sulfur compound from a fuel comprising subjecting the fuel to an ultra-deep hydrodesulfurization reaction in the presence of the catalyst of claim 1.

9. The method of claim 8 comprising carrying out the hydrodesulfurization reaction under the following conditions: temperatures in the range of from 280 to 400° C., hydrogen partial pressures in the range of from 1 to 20 MPa, the ratio of H₂ to the oil containing organic sulfur compounds in the range of from 50 to 1000 Nm³/m³, and typical liquid hourly space velocity in the range of from 0.1 to 10 h⁻¹ in the hydrodesulfurization reaction.

10. The method of claim 8 comprising, prior to the hydrodesulfurization reaction, pretreating the catalyst as follows:
a) grinding, kneading, and extrusion molding; and
b) carrying out sulfidation in-situ in a fixed-bed reactor in the presence of a mixture of hydrogen and a sulfur compound selected from the group consisting of hydrogen sulfide, carbon disulfide, and dimethyl disulfide at a temperature of from 300 to 450° C. for 2-10 hours.
